(19) United States
(12) Patent Application Publication
(10) Pub. No.: US 2005/0260113 A1
(43) Pub. Date: Nov. 24, 2005

(54) Agents for reducing atmospheric oxidising pollutants

(76) Inventor: Martyn Vincent Twigg, Cambridge (GB)

Correspondence Address: RATNERPRESTIA, P O BOX 980, VALLEY FORGE, PA, 19482-0980, US

(21) Appl. No.: 10/478,038

(22) PCT Filed: May 15, 2002
(86) PCT No.: PCT/GB02/02147

§ 371 Date: May 14, 2004

(30) Foreign Application Priority Data
May 15, 2001 (GB) 0111735.7

(51) Int. Cl. B01D 53/56

(52) U.S. Cl. 423/239.1

(57) ABSTRACT

A method of reducing atmospheric oxidising pollutants comprises contacting an atmospheric oxidising pollutant, such as ozone, with a precious metal-free reducing agent, wherein the reducing agent comprises at least one transition clement and/or one or more compounds including at least one transition element wherein the standard electrode potential of the redox reaction including the transition element and an ionic species of the transition element or between the ionic species of the transition element present in the or each compound and a further ionic species of the transition element is less than +1.0 volt. Illustrative reducing agents include a mixture of, optionally reduced, copper (II) oxide and zinc oxide on an alumina support, copper (II) oxide per se, and iron oxide on a mixed alumina/ceria support or a mixture of any two or more thereof.

The present invention relates to precious metal-free agents for reducing atmospheric oxidising pollutants such as ozone (O₃) or nitrogen dioxide (NO₂).

By “atmospheric oxidising pollutant” herein, we mean an atmospheric pollutant that has the potential to oxidise other atmospheric pollutants in a redox reaction. Illustrative examples of atmospheric oxidising pollutants include O₃, NO₂, dinitrogen tertroxide (N₂O₄) and sulfur trioxide (SO₃).

Ground-level O₃, a component of smog, is created from the reaction of nitrogen oxides (NOx) and hydrocarbons (HC), from vehicle and industrial emissions. Aldehydes, organic species having a relatively high Maximum Incremental Reactivity adjustment factor (MIR) also known as carter factors (as defined by “Californian Non-methane organic gases test procedures”, The California Environmental Protection Agency Air Resource Board dated Aug. 5, 1999), are also produced. Part of this reaction is catalysed by sunlight and can be represented by two equations:
O₂+RCH₂CH₃+NO→RCH₂CHO+NO₂; and (i)
NO₂+O₂→^{hv}O₃+NO. (ii)
Smog can cause asthma and respiratory ailments and is a particular problem in the southern California basin, Los Angeles and Houston, Tex. in the USA.

In WO 96/22146, Engelhard describes the concept of coating an atmosphere-contacting surface of a vehicle with a composition for treating one or more atmospheric pollutant, such as O₃ alone, O₃ and carbon monoxide (CO) or O₃, CO and HC. The surface is preferably that of a heat exchanger, such as a radiator or air conditioner condenser, located within the vehicle's engine compartment As the vehicle is propelled through the atmosphere, pollutants suspended in the atmosphere contact the composition and, depending on the formulation of the composition, it catalyses the reduction of the atmospheric oxidising pollutant O₃ to oxygen, and/or the oxidation of the atmospheric reducing pollutant carbon monoxide to carbon dioxide and/or of HC to water and carbon dioxide.

Engelhard markets a vehicle radiator having a catalytic coating for reducing O₃ under the trade name PremAir®. Details of PremAir® can also be found on Engelhard's website at www.Engelhard.com/premair. It is also described in its WO 96/22146. We understand that the active material on the marketed radiators is a manganese-based component, cryptomelane (KMn₈O₁₆.xH₂O, structurally related to α-MnO₂). Coated radiators have been fitted on certain Volvo production passenger vehicles, e.g. the S80 luxury sedan in USA and throughout Europe.

Catalytically coated heat exchangers are also used for treating aeroplane cabin air and for reducing O₃ emissions from computer printers, photocopiers etc.

Modern heat exchangers for use in vehicles are made from aluminium or aluminium alloys and are manufactured by companies such as Visteon, Delphi and Valeo. Heat exchangers for non-vehicle applications can also be made from aluminium or aluminium alloys. Hereinafter “aluminium” will be used to refer to aluminium and alloys of aluminium.

Aluminium is a relatively reactive metal. For example, it is known that when aluminium is exposed to atmospheric oxygen it develops a surface coating of oxide. Accordingly, when an aluminium heat exchanger is coated with a catalytic coating, such as the cryptomelane-based composition used in Engelhard's Premair® system, it is important that the composition does not react with the aluminium substrate. If the catalytic coating does react with and/or promote the corrosion of the aluminium substrate, this can drastically reduce the working life of the heat exchanger. In vehicle applications, heat exchangers are exposed to conditions which can promote metallic corrosion including moist air, salt and/or grit.

To test the ability of vehicle components to withstand corrosion, there have been devised certain standard laboratory cyclic salt spray corrosion tests termed “SWAAT” (e.g. ASTM G-85 A3 adapted from ASTM B117). Engelhard has been at pains to point out in its Society of Automotive Engineers (SAE) presentations (see SAE 982728 and 1999-01-3677) that the application of its catalytic coatings does not affect the resistance to corrosion of an aluminium radiator core and fully assembled radiators as tested by SWAAT. Furthermore, it has performed its own laboratory galvanic corrosion tests to show that brazed joints to the aluminium core are not prone to corrosion (see the SAE papers mentioned above). In the SWAAT test no leaks were detected following up to 1700 hours of the cyclic salt spraying of both Engelhard's coated aluminium radiator and a control un-coated aluminium radiator; independent tests concluded that, in the galvanic corrosion tests, no adverse galvanic corrosion effects would be expected from application of the reducing agent coating on aluminium radiators as shown by galvanic current measurements.

However, we believe that, in practice, the aluminium vehicle radiators including the PremAir® manganese-based catalytic coatings are indeed more susceptible to corrosion following prolonged use as compared with non-coated radiators. Without wishing to be bound by theory, we believe that this is because under acidic conditions, the oxidation potential of Mn⁴⁺ (the redox state of manganese in MnO₂) and Mn²⁺ as measured by the standard electrode potential is relatively high being +1.1406 volt. Increased corrosivity of a catalytic coating will have an economic impact on the vehicle manufacturer or its customer, in that the radiator will need to be replaced earlier than for an un-coated radiator, either within warranty or at the cost of the vehicle owner.

We have now found a number of alternative precious metal-free reducing agents to those described by Engelhard in WO 96/22146 that show similar or higher activity for reducing atmospheric oxidising pollutants such as O₃ compared with Engelhard's manganese-based catalyst components at the same ambient temperature. Furthermore, we believe that our alternative reducing agents are less likely to cause corrosion to an aluminium substrate in SWAAT and Engelhard's galvanic corrosion tests when compared with Engelhard's manganese-based catalysts.

According to a first aspect, the invention provides a method of reducing atmospheric oxidising pollutants, which method comprises contacting an atmospheric oxidising pollutant with a precious metal-free reducing agent, wherein the reducing agent comprises at least one transition element and/or one or more compounds including at least one transition element wherein the standard electrode potential of the redox reaction including the transition element and an ionic species of the transition element or between the ionic species of the transition element present in the or each compound and a further ionic species of the transition element is less than +1.0 volt.

For the purposes of the present invention, “atmosphere” as defined herein is the mass of air surrounding the earth, and “atmospheric pollutant” etc. should be interpreted accordingly. For the avoidance of doubt, the atmosphere is not comprised of any atmospheric oxidising pollutant present in a gas exhausted from an engine unless and until the gas exits to atmosphere an exhaust system carrying it.

By “precious-metal free” we mean the absence of a catalytically active amount of a precious metal such as gold, silver or any platinum group metal, e.g. platinum, palladium or rhodium.

By “transition element” herein, we mean any element in groups 1B, 2B, 3B, 4B, 5B, 6B, 7B or 8B of the periodic table.

According to a second aspect, the invention provides an apparatus for reducing atmospheric oxidising pollutants, which apparatus comprises an atmosphere contacting surface, a composition including a precious metal-free reducing agent supported on the surface wherein the reducing agent comprises at least one transition element and/or one or more compounds including at least one transition element wherein the standard electrode potential of the redox reaction including the transition element and an ionic species of the transition element or between the ionic species of the transition element present in the or each compound and a flier ionic species of the transition element is less than +1.0 volt and means for causing movement of the surface relative to the atmosphere, whereby atmospheric oxidising pollutants contacting the supported reducing agent are reduced.

Preferably, the transition element is copper, iron or zinc or a mixture of any two or more thereof. The or each compound including one or more transition element can be any suitable compound such as an oxide, carbonate, nitrate or hydroxide, but is preferably an oxide. In some circumstances, it is preferable to reduce the transition element in a transition element-including compound if in the reduced form the reducing agent is more active in its intended use. Compounds including transition elements prior to reduction can be referred to as ‘precursor’. For example, in a preferred embodiment the reducing agent is CuO/ZnO//Al₂O₃ is the precursor and the active form of the reducing agent is obtained by reducing the CuO to give Cu/ZnO//Al₂O₃. The reduced form of a transition element can be stabilised with suitable stabilisers as appropriate.

If supported, the transition element or transition element compound is preferably supported on a high surface area oxide selected from alumina, ceria, silica, titania, zirconia, a mixture or a mixed oxide of any two or more thereof.

According to preferred embodiments, the active form of the reducing agent is copper (II) oxide per se, a mixture of reduced copper (II) oxide and zinc oxide on an alumina support or iron oxide on a mixed alumina/ceria support.

Methods of manufacturing copper (II) oxide, copper (II) oxide and zinc oxide on Al₂O₃ or iron oxide on a mixed alumina/ceria support are known to a person skilled in the art or can be deduced by reasonable experimentation, e.g. by co-precipitation of the or each transition element component and/or support. For example, in a CuO/ZnO//Al₂O₃ reducing agent the Cu and Zn can be co-precipitated and the already formed Al₂O₃ added thereto. Specific details of the manufacturing processes will not be given here.

The CuO/ZnO//Al₂O₃ reducing agent composition can be any suitable for the intended e.g. CuO30:ZnO60:Al₂O₃10 or CuO60:ZnO30:Al₂O₃ 10. Commercially available forms of these compositions are available from ICI as ICI 52-1 and ICI 51-2 respectively. Commercially available CuO/ZnO//Al₂O₃ is sold as pellets, which can be ground to the required particle size.

The atmosphere-contacting surface according to the invention preferably comprises aluminium or an aluminium alloy.

The composition can be applied to a support surface in a formulation including suitable binders, stabilisers, age resistors, dispersants, water resistance agents, adhesion improvement agents etc. known to persons skilled in the art. Binders include polymeric binders which can be thermosetting or thermoplastic polymeric binders and are listed in WO 96/22146, incorporated herein by reference. However, we most prefer to use water soluble binders, particularly organic binders including vinyl and acrylic water soluble binders e.g. PVA, cellulosic binders including ether or ester or semi-synthetic cellulosic binders, preferably hydroxypropyl- or methyl cellulose or mixtures of any two or more of the above mentioned binders, e.g. a mixture of PVA and hydroxypropyl cellulose. The preferred binders are described in our co-pending application entitled “Compositions including agents for reducing atmospheric oxidising pollutants” filed on the same date as the present application.

An important advantage of the compositions including the preferred binders is that they can be cured at relatively low temperatures, e.g. ≦90° C., compared with compositions including Engelhard's preferred binders. In particular, this feature enables the preparation of a radiator core fitted with its plastic tanks in a continuous process, i.e. without having first to prepare a coated core and then fit the plastic tanks thereto. However, with compositions requiring higher curing temperatures, the coated radiator core must be prepared before assembling the tanks to prevent heat damage to the tanks during curing. Thus, not only is there an economic advantage in that the energy required to cure the composition is reduced, but the process of radiator manufacture is simplified.

The percent conversion of atmospheric oxidising and reducing pollutants depends on the temperature and space velocity of the atmospheric air relative to the atmosphere-contacting surface and the temperature of the atmosphere contacting surface. An advantage of the present invention is that relatively large volumes of atmospheric air can be treated at relatively low temperatures. An indication of the amount of air being treated as it passes the trap material is commonly referred to as the space velocity. This is measured as the volume of air per hour which passes across the volume of the trap material and is measured in e.g. litres per hour of air divided by the litres of trap material. That is, the units are reciprocal hours. Space velocities encountered by a radiator mounted in an engine compartment at typical driving speeds of up to 100 mph can range from 0 to 1,000,000 hr⁻¹, e.g. 300,000 to 650,000 hr⁻¹ or 400,000 to 500,000 hr⁻¹.

That the reducing agents for use in the present invention are at least as active for reducing O₃ as Engelhard's Premair® manganese-based components is shown in Example 4 below, where a 20 mm thick aluminium radiator coated with a composition including our mixture of “reduced” copper (II) oxide and zinc oxide on an alumina support gave a % O₃ conversion of 94% whereas the commercially available 40 mm thick Premair® aluminium radiator including cryptomelane had a % O₃ conversion of 100%. From Example 1 we know that O₃ conversion activity improves significantly if the reducing agent loading is doubled. Therefore, if our coating were applied on a 40 mm thick unit at the same mass per unit volume, we would expect the O₃ conversion to improve from 94%, probably to 100%.

In a preferred embodiment the means for causing movement of the surface relative to the atmosphere is a power plant. The power plant can be an engine fuelled by gasoline, diesel, liquid petroleum gas, natural gas, methanol, ethanol, methane or mixtures of any two or more thereof, an electric cell, a solar cell or a hydrocarbon or hydrogen-powered fuel cell.

Preferably the support surface is on or in a vehicle, and the movement-causing means is a power plant as described above. The vehicle can be a car, van, truck, bus, lorry, aeroplane, boat, ship, airship or train, for example. A particularly preferred application is for use in heavy-duty diesel vehicles, i.e. vans, trucks, buses or lorries, as defined by the relevant European legislation.

The atmosphere-contacting surface can be any suitable surface that encounters and contacts the atmosphere, most preferably, at relatively large flow rates as the vehicle moves through the atmosphere. The support surface is preferably located at or towards the leading end of the vehicle so that air will contact the surface as the vehicle is propelled through it. Suitable support locations are fan blades, wind deflectors, wing mirror backs or radiator grills and the like. Alternative locations for supporting the trap material are given in WO 96/22146 and are incorporated herein by reference.

In a most preferred embodiment the apparatus comprises a heat exchange device such as a radiator, an air conditioner condenser, an air charge cooler (intercooler or aftercooler), an engine oil cooler, a transmission oil cooler or a power steering oil cooler. This feature has the advantage that the heat exchange device reaches above ambient temperatures, such as up to 140° C., e.g. 40° C. to 1-10° C., at which, for example, O₃ reduction can occur more favourably. A further advantage of using heat exchangers as the support surface for the or each reducing agent composition is that in order to transfer heat efficiently they have a relatively large surface area comprising fins or plates extending from the outer surface of a housing or conduit for carrying a fluid to be cooled. A higher surface area support surface provides for a greater level of contact between the each reducing agent composition and the atmosphere.

By “ambient” herein we mean the temperature and conditions, e.g. humidity, of the atmosphere.

In a particularly preferred embodiment, the apparatus comprises a radiator and/or air conditioning condenser which is housed within a compartment of a vehicle also including the power plant, e.g. an air-cooled engine. This provides the advantage that the radiator and/or condenser is exposed to ambient atmospheric air as the vehicle is propelled through the atmosphere whilst being protected by the radiator grill from damage by particulates, e.g. grit or stones, and from the impact of flies. For mid- and rear-engine vehicles, air intakes and conduits can be arranged to carry atmospheric air to and from the supported reducing agent. A further advantage of locating the radiator and/or condenser in the engine compartment is that exposure to corrosion-causing agents such as moist air, salt and/or grit is reduced and hence so too is the rate of any corrosion. Whilst the radiator and/or condenser can be formed of any material, it is usually a metal or an alloy. Most preferably, the heat exchanger is aluminium or an alloy containing aluminium.

Another advantage of using a heat exchanger, such as a radiator, as the support surface for the reducing agent is that the radiator is releasably attached to a vehicle, typically in the engine compartment of the vehicle. This enables coated radiators and other heat exchangers to be retrofitted to the vehicle, e.g. during normal servicing of the vehicle, thereby to improve the pollutant treating ability of the vehicle.

Alternatively the apparatus can be non-mobile, and the surface is associated with the movement-causing means to provide the required relative movement between the surface and the atmosphere. For example, the surface can be one or more blades for causing movement of air. In one embodiment the blades are fan blades for cooling a stationary power plant such as for powering an air conditioning unit or advertising hoarding. In another embodiment the blade is a fan or turbine blade for drawing air into the air conditioning system of a building.

In addition to, or instead of, the support surface being on a fan or turbine blade, the surface can be the internal surfaces of pipes, tubes or other conduits for carrying atmospheric air, e.g. in an air conditioning system for a vehicle or a building and condenser elements in air conditioning units provided that the movement of the air is caused by a movement causing means.

In order that the invention may be more fully understood, the invention will now be described by reference to the following illustrative Examples and by reference to the accompanying drawings, in which:

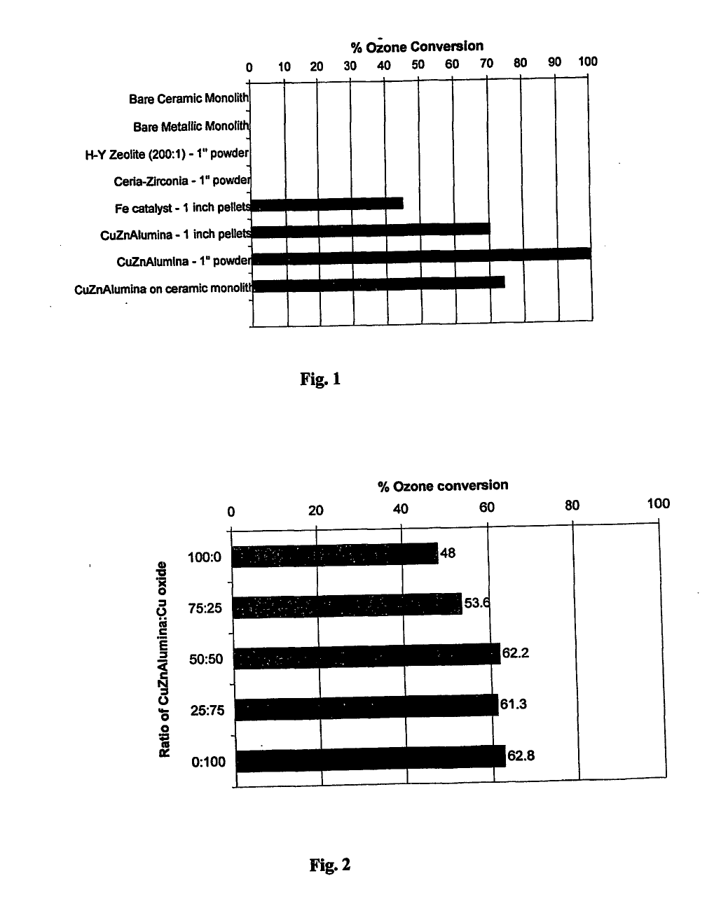

FIG. 1 is a bar chart showing the % O₃ conversion for various candidate reducing agents;

FIG. 2 is a bar chart showing the effect on % O₃ conversion of increasing CuO content on the O₃ conversion of Cu/ZnO//Al₂O₃; and

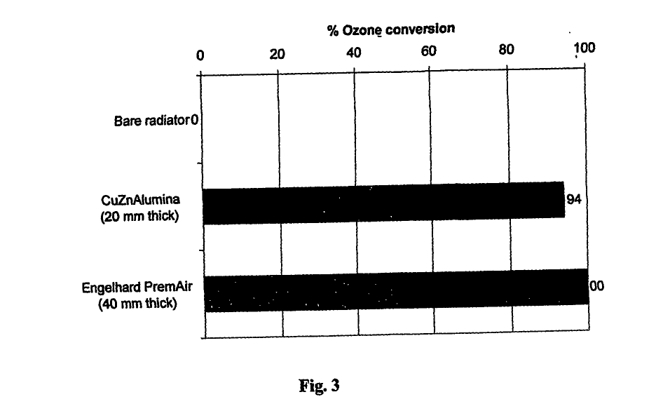

FIG. 3 is a bar chart comparing the % O₃ conversion of a Cu/ZnO//Al₂O₃ reducing agent composition with a bare radiator and a Premair® radiator.

### EXAMPLE 1

To screen candidate O₃ reducing agents at room temperature, a test rig comprising an upstream O₃ generator, a stainless steel tube including metal mesh to pack a reactor bed material therebetween and a downstream O₃ detector was set up in a fume cupboard. O₃ was generated and mixed with air before passing through the reactor bed containing powder or pellet samples. The exhaust gas from the reactor bed was passed through the O₃ detector (measured in 5 ppm units) before being vented. An inlet O₃ concentration of ˜200 ppm at a space velocity (GHSV) of ˜1000/hr was used. Whilst higher space velocities would be observed at, e.g. the surface of a radiator, and atmospheric O₃ concentrations are present in the parts per billion range, the results were useful to compare directly the potential of each material tested to reduce O₃.

The following materials were tested: H—Y zeolite (Si:Al ratio 200:1)—1″ powder bed; a ceria-zirconia mixed oxide 1″ powder (ceria-zirconia mixed oxide is an oxygen storage component used in three way catalyst compositions); iron oxide on a ceria support (hereinafter “Fe reducing agent”)—1″ pellet bed; Cu/ZnO//Al₂O₃—1″ pellet bed; Cu/ZnO//Al₂O₃—1″ powder bed; and Cu/ZnO//Al₂O₃ on a ceramic monolith.

FIG. 1 shows the results of a comparison of the O₃ decomposition activity of these materials tested in the rig described above at room temperature. No O₃ conversion was observed for the empty system or over a bare metallic or ceramic substrate. Zeolite and ceria-zirconia were also found to have no O₃ decomposition activity. The best material tested was Cu/ZnO//Al₂O₃; this gave approximately 70% conversion over a 1″ bed of pellets, compared to 45% for a 1″ bed of Fe reducing agent. CulZnO//Al₂O₃ coated onto a ceramic monolith. As expected, the form of the reducing agent material was important—after grinding the Cu/ZnO//Al₂O₃ pellets into a fine powder, the O₃ conversion increased to 100%.

It was also confirmed that the O₃ conversion is dependent on the reducing agent loading. For Cu/ZnO//Al₂O₃ powder, as the loading increased from 0.5 to 1 g the O₃ conversion increased from 48 to 63%. At higher loadings 100% conversion was achieved. A similar trend was observed for the Fe reducing agent; doubling the reactor bed depth from 1″ to 2″ increased the O₃ conversion from 45 to 100%, while reducing the bed depth to ½″ reduced the O₃ conversion to 25%.

### EXAMPLE 2

To test whether the O₃ conversion of our best candidate O₃ reducing agent Cu/ZnO//Al₂O₃ can be improved by including copper (II) oxide, a series of materials were prepared by mixing Cu/ZnO//Al₂O₃ and copper (II) oxide at ratios of 100:0, 75:25, 50:50, 25:75 and 0:100 by mass. The O₃ conversion was measured using the rig and procedure described in Example 1 above for 0.5 g of each powder and the results are shown in FIG. 2. They clearly show that adding copper oxide increases the O₃ conversion from 48% for the undoped material to ˜62% for material with ≧50% copper oxide.

### EXAMPLE 3

There is now described a composition including the Cu/ZnO//Al₂O₃ reducing agent component for application to e.g. an aluminium alloy radiator substrate. Cu/ZnO//Al₂O₃ was mixed with an aqueous solution of hydroxypropyl cellulose binder, Klucel™, to a concentration of 10% wt/wt. The coating was applied to each side of a Visteon aluminium alloy radiator of 20 mm thickness using a compressed air spray gun and then cured at or below 90° C.

### EXAMPLE 4

This Example is designed to compare the O₃ conversion activity of our Cu/ZnO//Al₂O₃ reducing agent with that of Engelhard's Premair® catalyst.

A Ford Mondeo radiator manufactured by Visteon was supplied for coating. This radiator, consisting of uncoated aluminium foil, has a face area of 16″×10″ and a thickness of 20 mm. The unit was coated with a washcoat including the Cu/ZnO//Al₂O₃ and a 10% wt/wt aqueous solution of a hydroxypropyl cellulose binder (trade name “Klucel”) described in Example 3 above using a compressed air spray gun. Two layers were applied to each side, loading of 68 g or 0.54 g/in³. After drying, the radiator was found to have a thick, dark brown coating of approximately 20 mm total thickness which had acceptable adhesion and resisted most physical abrasion.

The activity of the coated radiator was tested and compared to a bare aluminium alloy radiator and an Engelhard Premair® coated aluminium alloy radiator. Activity testing was carried out in a similar manner to the material screening described in Example 1 above, with the powder bed reactor modified so that it clamped onto either side of the radiator. The results can be seen in FIG. 3. 94% O₃ conversion was obtained over the Cu/ZnO//Al₂O₃ coated aluminium radiator, this compared favourably with the 100% conversion obtained over the Premair® radiator. The thickness of the Premair® radiator was approximately 40 mm, twice that of the radiator coated with our Cu/ZnO//Al₂O₃ composition. No conversion was obtained from a bare radiator.

1. A method of reducing atmospheric oxidising pollutants, which method comprises contacting an atmospheric oxidising pollutant with a precious metal-free reducing agent, which reducing agent comprising a mixture of copper (II) oxide and zinc oxide carried on a support.

2. A method according to claim 1, wherein the support is a high surface area oxide selected from the group consisting of alumina, ceria, silica, titania, zirconia and mixed oxides of any two or more thereof.

3. A method according to claim 1, wherein the reducing agent is Cu/ZnO//Al₂O₃.

4. A method according to claim 1, wherein the atmospheric oxidising pollutant is selected from the group consisting of O₃, NO₂, N₂O₄ and SO₃.

5. An apparatus for reducing atmospheric oxidising pollutants, which apparatus comprises an atmosphere contacting surface; a composition including a precious metal-free reducing agent supported on the surface, wherein the reducing agent is a mixture of copper (II) oxide and zinc oxide carried on a support; and means for causing movement of the surface relative to the atmosphere, whereby atmospheric oxidising pollutants contacting the supported reducing agent are reduced.

6. Apparatus according to claim 5, wherein the support is a high surface area oxide selected from the group consisting of alumina, ceria, silica, titania, zirconia and mixed oxides of any two or more thereof.

7. Apparatus according to claim 5, wherein reducing agent is in the reduced form.

8. Apparatus according to claim 7, wherein the reducing agent is Cu/ZnO//Al₂O₃.

9. Apparatus according to claim 5, wherein the atmosphere-contacting surface comprises aluminium or an aluminium alloy.

10. Apparatus according to claim 5, wherein the composition further includes a thermosetting polymeric binder, a thermoplastic polymeric binder or a mixture of a thermosetting polymeric binder and a thermoplastic polymeric binder.

11. Apparatus according to claim 10, wherein the binder is a water-soluble binder.

12. Apparatus according to claim 11, wherein the water-soluble binder is a cellulosic binder.

13. Apparatus according to claim 12, wherein the cellulosic binder is selected from the group consisting of an ether cellulosic binder, an ester cellulosic binder and a semi-synthetic cellulosic binder.

14. Apparatus according to claim 11, wherein the water-soluble binder is a vinyl or acrylic binder.

15. Apparatus according to claim 5, wherein the means for causing movement of the surface relative to the atmosphere is a power plant.

16. Apparatus according to claim 15, wherein the power plant is an engine fuelled by gasoline, diesel, liquid petroleum gas, natural gas, methanol, ethanol, methane or a mixture of any two or more thereof.

17. Apparatus according to claim 5, wherein the apparatus comprises a heat exchanger.

18. Apparatus according to claim 17, wherein the heat exchanger is a radiator and/or a condenser.

19. A vehicle including an apparatus according to claim 5.

20. A vehicle according to claim 19, wherein the apparatus comprises a radiator housed in an engine compartment of the vehicle.

21. Apparatus according to claim 5, wherein the composition further includes a latex binder.

22. Apparatus according to claim 12, wherein the cellulosic binder is a hydroxypropyl- or methylcellulose binder.

23. Apparatus according to claim 11, wherein the water soluble binder is polyvinyl alcohol or ammonium polymethacrylate.

24. Apparatus according to claim 15, wherein the power plant is an electric cell, a solar cell or a hydrocarbon or hydrogen-powered fuel cell.
